(19) United States
(12) Patent Application Publication
(10) Pub. No.: US 2021/0222663 A1
(43) Pub. Date: Jul. 22, 2021

(54) IGNITION COIL MOUNT FOR REDUCED VIBRATION

(71) Applicant: DENSO International America, Inc., Southfield, MI (US)

(72) Inventors: Harrison BOLL, Grosse Pointe Farms, MI (US); Jeongung HWANG, Northville, MI (US)

(73) Assignee: DENSO International America, Inc., Southfield, MI (US)

(21) Appl. No.: 16/745,816

(22) Filed: Jan. 17, 2020

(51) Int. Cl. F02P 13/00; F02F 1/24; H01F 38/12; F02P 15/00

(52) U.S. Cl. CPC F02P 13/00; F02P 15/00; H01F 38/12; F02F 1/242

(57) ABSTRACT

An assembly for an engine includes an ignition coil, a fastener, a spring member, and a resilient damper member. The ignition coil includes a main body and a mounting flange. The mounting flange defines a flange bore. The fastener includes a shaft and a head. The head extends radially outward from a first end portion of the shaft. The shaft extends through the flange bore such that a second end portion of the shaft protrudes from the flange bore. The second end portion of the shaft is threaded. The spring member is disposed about the first end portion of the shaft axially between the head and the mounting flange and biases the mounting flange axially away from the head. The resilient damper member is disposed about the shaft and configured to axially separate the mounting flange from an engine component to which the fastener couples the mounting flange.

### FIELD

The present disclosure relates to an engine ignition coil assembly and, more specifically, for an ignition coil mount.

### BACKGROUND

The statements in this section merely provide background information related to the present disclosure and may not constitute prior art.

Internal combustion engines, such as those used in vehicles, typically include one or more ignition coils connected to an ignition device (e.g., a spark plug). The ignition coil operates or controls the ignition device to provide a source of ignition (e.g., a spark) within a combustion chamber of the engine. The ignition coil is typically mounted to a component of the engine such as a valve cover which is typically coupled to the engine head and covers the intake and exhaust valves.

### SUMMARY

An assembly for an engine includes an ignition coil, a fastener, a spring member, and a resilient damper member. The ignition coil includes a main body and a mounting flange. The mounting flange defines a flange bore. The fastener includes a shaft and a head. The head extends radially outward from a first end portion of the shaft. The shaft extends through the flange bore such that a second end portion of the shaft protrudes from the flange bore. The second end portion of the shaft is threaded. The spring member is disposed about the first end portion of the shaft axially between the head and the mounting flange and biases the mounting flange axially away from the head. The resilient damper member is disposed about the shaft and configured to axially separate the mounting flange from an engine component to which the fastener couples the mounting flange.

In a further form, the present disclosure is directed toward an assembly for an engine including an engine component, a connected component, a fastener, a biasing member, and a damper member. The engine component defines an aperture. The connected component includes a mounting flange. The mounting flange defines a flange bore. The fastener couples the connected component to the engine component. The fastener includes a head and a shaft. The shaft extends axially from the head and extends through the flange bore. A distal end portion of the shaft is received in the aperture of the engine component. The biasing member biases the mounting flange axially away from the head and toward the engine component. The damper member is disposed axially between the mounting flange and the engine component.

In another form, the present disclosure is directed toward an assembly for an engine including a valve cover, an ignition coil, a fastener, a biasing member, and a damper member. The valve cover defines a threaded aperture. The ignition coil includes a coil body and a mounting flange. The mounting flange defines a flange bore. The fastener includes a head and a shaft. The shaft extends axially from the head and extends through the flange bore. A distal end portion of the shaft is threaded and matingly engaged with the threaded aperture. The biasing member is disposed about the shaft and axially between the head and the mounting flange. The biasing member biases the mounting flange axially away from the head. The damper member is disposed about the shaft and axially between the mounting flange and the valve cover. The damper member inhibits contact between the valve cover and the mounting flange.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a right side view of an example vehicle in accordance with the teachings of the present disclosure;

FIG. 2 is a perspective view of an engine of the vehicle of FIG. 1, illustrating an ignition assembly of the engine;

FIG. 3 is a perspective view of an ignition coil of the ignition coil assembly of FIG. 2;

FIG. 4 is a cross-sectional view of a portion of the ignition assembly of FIG. 2, including the ignition coil of FIG. 3; and

FIG. 5 is a cross-sectional view of a portion of a mount of the ignition assembly of FIG. 4.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Ignition coils can experience high amounts of vibration during operation of the engine. This vibration can reduce the life of the coil, e.g., through fatigue of the mounting points or the electrical components.

The present disclosure provides for an engine ignition coil assembly and mount that overcomes these and other issues with typical ignition coils.

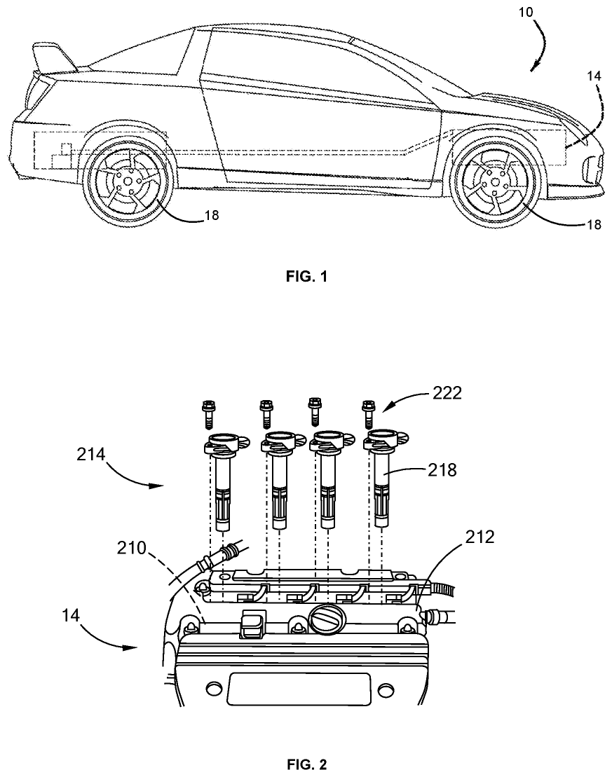

Referring to FIG. 1, a vehicle 10 is illustrated. The vehicle 10 includes an internal combustion engine 14. In the example provided, the engine 14 is the engine of the vehicle 10, though the engine 14 may be used in other applications (e.g., machinery, generators). While a passenger-type automobile is illustrated as the example vehicle 10, other types of vehicles may include the engine 14 such as trucks, recreational vehicles, watercraft, all-terrain vehicles, and any other suitable vehicle. The engine 14 may provide drive torque to one or more wheels 18 of the vehicle 10. In the example provided, the engine 14 provides drive torque to the front wheels 18 of the vehicle such as through a transmission (not shown) of the vehicle for example, though other configurations may be used such as the rear wheels 18 or all of the wheels 18. Additionally or alternatively, the engine 14 may charge a vehicle battery (not shown) that may supply electric power to electric motors (not shown) that provide some or all of the drive torque to the wheels 18 (e.g., an electric or hybrid vehicle).

Referring to FIG. 2, the engine 14 of the example provided is a piston-cylinder engine including a combustion chamber (not shown) at least partially defined by a cylinder head 210 and a piston (not shown). The combustion chamber (not shown) may also be at least partially defined by a portion of an engine block (not shown) of the engine 14. A cover 212 is attached to the cylinder head 210 and covers intake and exhaust valves (not shown) and, in the case of cam-driven valves, the intake and exhaust cams (not shown) of the engine 14. The engine 14 includes one or more ignition assemblies 214. Each ignition assembly includes an ignition coil 218, an ignition device (not shown), and mounting hardware 222.

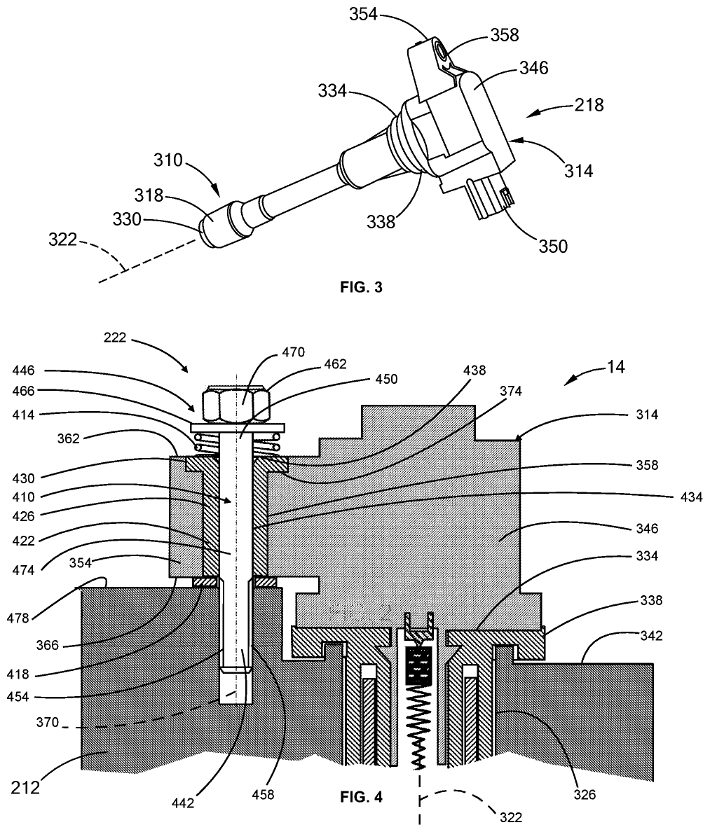

Referring to FIGS. 3 and 4, the ignition coil 218 includes a proximal portion 310 and a distal portion 314. The proximal portion 310 includes a lower housing 318 that extends longitudinally along a central axis 322 from the distal portion 314. The proximal portion 310 is configured to be received within a bore 326 defined by the cover 212. An end 330 of the proximal portion 310 that is opposite the distal portion 314 is configured to connect for electrical communication to the ignition device (not shown) within the cylinder head 210 (FIG. 2). The ignition device (not shown) can be any suitable type of ignition device configured to provide a source of ignition (e.g., a spark) within the combustion chamber (not shown) of the engine 14. One non-limiting example of the ignition device (not shown) is a spark plug. An opposite end 334 of the proximal portion 310 can include a seal ring 338 that can form a seal with the cover 212 to inhibit fluid and debris from entering the bore 326. In the example provided, the seal ring 338 is disposed external of the bore 326 and extends radially outward of the bore 326 to seal on a surface 342 of the cover 212, though other configurations can be used. For example, the seal ring 338 can seal on a surface of the cover 212 (FIG. 2) that covers valves (not shown) of the engine 14. The seal ring 338 may be integrally formed with the lower housing 318 or may be attached thereto.

The distal portion 314 is coupled to the opposite end 334 of the proximal portion 310 and disposed exterior of the cover 212. The distal portion 314 includes an upper housing 346, an electrical connector 350, and a mounting flange 354. The electrical connector 350 is configured to receive power and/or electrical signals for controlling operation of the ignition device (not shown).

Referring specifically to FIG. 4, the mounting flange 354 is configured to cooperate with the mounting hardware 222 to structurally attach the ignition coil 218 to a component of the engine 14. In the example provided, the mounting flange 354 is a plastic or composite material and is integrally formed with the upper housing 346. In the example provided, the mounting flange 354 and mounting hardware 222 attach the upper housing 346 to the cover 212 and support the ignition coil 218 relative to the cover 212. The mounting flange 354 extends radially outward from the upper housing 346 and radially outward of the proximal portion 310. The mounting flange 354 defines a flange bore 358 extending through top and bottom faces 362, 366, respectively of the mounting flange 354. In the example provided, the flange bore 358 extends coaxially with an axis 370 that is parallel and offset from the central axis 322 of the proximal portion 310. In the example provided, the distal portion 314 only includes one mounting flange 354. In an alternate configuration, not specifically shown, the distal portion 314 may include more than one mounting flange 354. In the example provided, the flange bore 358 may be a countersunk bore such that it includes a recess 374 from the top faces 362, though other configurations can be used.

The mounting hardware 222 includes a fastener 410, a spring member 414, and a damper member 418. The mounting hardware 222 may also include a bush 422. The bush 422 includes a cylindrical body 426 and a bush flange 430. The cylindrical body 426 defines a bore 434 that is coaxial with the axis 370 of the flange bore 358. The cylindrical body 426 is disposed within the flange bore 358. The bush 422 can be coupled to the mounting flange 354 in any suitable manner, such as press-fit, overmolded, or adhesives for example. In the example provided, the bush 422 is a metal material (e.g., steel or aluminum). The bush flange 430 extends radially outward from a top end 438 of the cylindrical body 426 and is seated within the recess 374.

The fastener 410 includes a shaft 442 and a head 446. The shaft 442 is disposed coaxially about the axis 370. The head 446 is coupled to a first end portion 450 of the shaft 442 and generally extends radially outward of the shaft 442. A second end portion 454 of the shaft 442 is threaded. In the example provided, the threads of the second end portion 454 matingly engage with internal threads of a bore 458 defined by the cover 212. In an alternative configuration, the bore 458 may be defined by a different engine component such as the cover (not shown) that covers the cams (not shown) of the engine 14.

The head 446 includes a tool engagement portion 462 and a washer portion 466. In the example provided, the tool engagement portion 462 and washer portion 466 are coupled for common rotation with the shaft 442 and may be integrally formed therewith. In an alternative configuration, the tool engagement portion 462 is coupled for common rotation with the shaft 442, but the washer portion 466 is a separate washer that is rotatable relative to the tool engagement portion 462 and the shaft 442.

The washer portion 466 extends radially outward of the tool engagement portion 462 and is disposed axially between the tool engagement portion 462 and the top faces 362 of the mounting flange 354. In the example provided, the tool engagement portion 462 has perimeter faces 470 generally arranged in a hexagonal shape configured to be engaged by a wrench or socket (not shown) to rotate the tool engagement portion 462, though other shapes or tools may be used. In one alternative configuration, not specifically shown, the tool engagement portion 462 may include a recess configured to receive a tool (not shown) of a complementary shape, such as a hex or Torx bit for example.

In an alternative configuration, not specifically shown, the first end portion 450 of the shaft 442 may be threaded and the tool engagement portion 462 may be a nut matingly threadably engaged with the first end portion 450 of the shaft 442. In such an alternative configuration, the washer portion 466 may be coupled for common rotation with the nut or may be rotatable relative to the nut. In this alternative configuration, the second end portion 454 of the shaft 442 may be threadably received in the bore 458 or may be coupled to the cover 212 in a manner that inhibits rotation of the shaft 442 relative to the cover 212, such as press fit into the bore 458, welded to the cover 212, or by mating features (e.g., splines) with the bore 458.

An intermediate portion 474 of the shaft 442 is disposed axially between the first and second end portions 450, 454, respectively. The intermediate portion 474 extends through the bore 434 of the bush 422 and is free to rotate relative to the bush 422. In the example provided, the intermediate portion 474 is not threaded and fits in the bore with a slip fit.

The spring member 414 is disposed about the first end portion 450 of the shaft 442 axially between the washer portion 466 and the bush flange 430 of the bush 422. The spring member 414 is configured to bias the head 446 and bush 422 axially apart. Since the bush flange 430 of the bush 422 is seated in the recess 374, the spring member 414 biases the head 446 and mounting flange 354 axially apart. In the example provided, the spring member 414 is a compression coil spring, though the spring member 414 may be any suitable resilient material or configuration that elastically resists compression to apply an axial pre-load force on the fastener 410 (e.g., a Belleville washer, a wave spring).

The damper member 418 is an annular body disposed coaxially about the shaft 442 of the fastener 410 axially between the bottom faces 366 of the mounting flange 354 and a surface 478 of the cover 212 that defines the bore 458. In the example provided, the surface 478 is offset above the surface 342, though other configurations can be used. The damper member 418 is a resilient material configured to absorb and dampen vibrations between the cover 212 and the mounting flange 354. Some non-limiting examples include rubber or resilient plastics or polymers. In the example provided, the damper member 418 is in contact with the bottom faces 366 of the mounting flange 354, the cylindrical body 426 of the bush 422, and the engine component to which the ignition coil 218 is mounted, e.g., the cover 212.

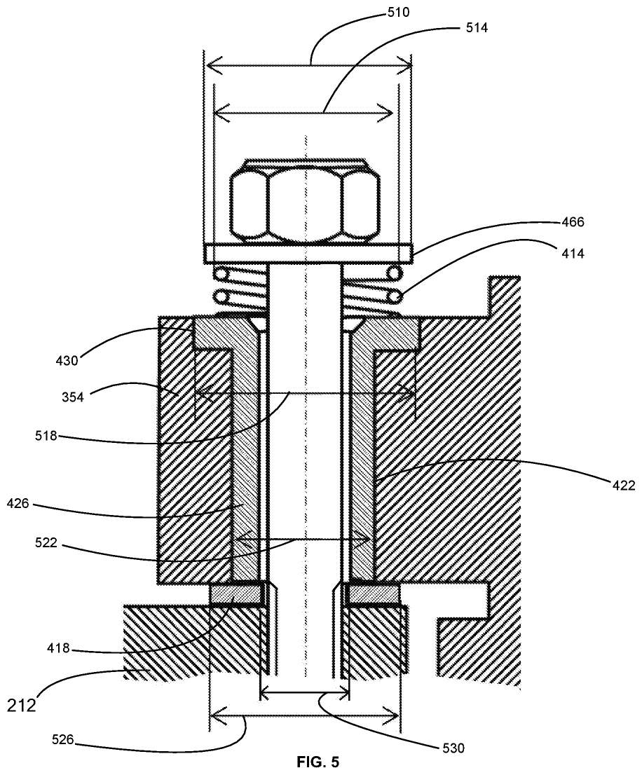

Referring to FIG. 5, in the example provided, the washer portion 466 has an outer diameter 510, the spring member 414 has an outer diameter 514, the bush flange 430 has an outer diameter 518, the cylindrical body 426 has an outer diameter 522 (similar to the flange bore 358), and the damper member 418 has an outer diameter 526. In the example provided, the outer diameter 510 of the washer portion 466 is greater than the outer diameter 514 of the spring member 414, and the outer diameter 518 of the bush flange 430 is greater than the outer diameter 514 of the spring member 414. Thus, the spring member 414 applies axial force to the mounting flange 354 via the bush 422 instead of directly to the mounting flange 354. In the example provided, the spring member 414 is in contact with the washer portion 466 and the bush flange 430 and is not in contact with the mounting flange 354. In the example provided, the outer diameter 518 of the bush flange 430 is greater than the outer diameter 522 of the cylindrical body 426, and the outer diameter 526 of the damper member 418 is greater than the outer diameter 522 of the cylindrical body 426. In the example provided, the damper member 418 has an inner diameter 530 that is less than the outer diameter 522 of the cylindrical body 426 of the bush 422.

The spring damper configuration described herein reduces the effects of engine vibration on the ignition coil, increasing the lifetime of the coil and allowing lighter, more economical materials to be used for the ignition coil 218.

Based on the foregoing, in one form, the present disclosure is directed toward an assembly for an engine including an ignition coil, a fastener, a spring member, and a resilient damper member. The ignition coil includes a main body and a mounting flange. The mounting flange defines a flange bore. The fastener includes a shaft and a head. The head extends radially outward from a first end portion of the shaft. The shaft extends through the flange bore such that a second end portion of the shaft protrudes from the flange bore. The second end portion of the shaft is threaded. The spring member is disposed about the first end portion of the shaft axially between the head and the mounting flange and biases the mounting flange axially away from the head. The resilient damper member is disposed about the shaft and configured to axially separate the mounting flange from an engine component to which the fastener couples the mounting flange.

In one form, the ignition coil assembly further includes a bush disposed within the flange bore and disposed about the shaft.

In another form, the bush includes a cylindrical body and a bush flange that extends radially outward from the cylindrical body.

In yet another form, the spring member biases the bush flange toward the mounting flange.

In still another form, the damper member contacts the bush.

In a further form, the bush has a first outer diameter and the damper member has a second outer diameter that is greater than the first outer diameter.

In yet a further form, the bush is a metal material and the mounting flange is a plastic or composite material.

In still a further form, the spring member is a coil spring.

In another form, the damper member is a rubber or polymer material.

In yet another form, the ignition coil assembly further includes a valve cover defining an aperture within which the second end portion of the shaft is received, wherein the valve cover is the engine component to which the fastener couples the mounting flange.

In still another form, the aperture of the valve cover is threaded and matingly engages the threads of the second end portion of the shaft.

In a further form, the head includes a tool engagement portion and a washer portion.

In yet a further form, the washer portion is coupled to the tool engagement portion for common rotation.

In a further form, the present disclosure is directed toward an assembly for an engine including an engine component, a connected component, a fastener, a biasing member, and a damper member. The engine component defines an aperture. The connected component includes a mounting flange. The mounting flange defines a flange bore. The fastener couples the connected component to the engine component. The fastener includes a head and a shaft. The shaft extends axially from the head and extends through the flange bore. A distal end portion of the shaft is received in the aperture of the engine component. The biasing member biases the mounting flange axially away from the head and toward the engine component. The damper member is disposed axially between the mounting flange and the engine component.

In still another form, the engine component is a valve cover and the connected component is an ignition coil.

In yet another form, the assembly further includes a bush. The bush includes a main body and a bush flange that extends radially outward of the main body. The biasing member biases the bush flange axially toward the mounting flange.

In still a further form, the assembly further includes a bush. The damper member is disposed about the shaft and has an outer diameter greater than an outer diameter of the bush.

In yet another form, the aperture of the engine component is threaded and matingly engages the threads of the distal end portion of the shaft.

In another form, the present disclosure is directed toward an assembly for an engine including a valve cover, an ignition coil, a fastener, a biasing member, and a damper member. The valve cover defines a threaded aperture. The ignition coil includes a coil body and a mounting flange. The mounting flange defines a flange bore. The fastener includes a head and a shaft. The shaft extends axially from the head and extends through the flange bore. A distal end portion of the shaft is threaded and matingly engaged with the threaded aperture. The biasing member is disposed about the shaft and axially between the head and the mounting flange. The biasing member biases the mounting flange axially away from the head. The damper member is disposed about the shaft and axially between the mounting flange and the valve cover. The damper member inhibits contact between the valve cover and the mounting flange.

In still another form, the assembly further includes a bush including a first portion and a second portion. The first portion has a first diameter. The second portion has a second diameter. The first diameter is greater than the second diameter. The first diameter is greater than a diameter of the biasing member. The second diameter is greater than a diameter of the damper member.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, manufacturing technology, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An assembly for an engine comprising:
an ignition coil including a main body and a mounting flange, the mounting flange defining a flange bore;
a fastener including a shaft and a head, the head extending radially outward from a first end portion of the shaft, the shaft extending through the flange bore such that a second end portion of the shaft protrudes from the flange bore, the second end portion of the shaft being threaded;
a spring member disposed about the first end portion of the shaft axially between the head and the mounting flange and biasing the mounting flange axially away from the head; and
a resilient damper member disposed about the shaft and configured to axially separate the mounting flange from an engine component to which the fastener couples the mounting flange.

2. The assembly according to claim 1 further comprising a bush disposed within the flange bore and disposed about the shaft.

3. The assembly according to claim 2, wherein the bush includes a cylindrical body and a bush flange that extends radially outward from the cylindrical body.

4. The assembly according to claim 3, wherein the spring member biases the bush flange toward the mounting flange.

5. The assembly according to claim 2, wherein the resilient damper member contacts the bush.

6. The assembly according to claim 5, wherein the bush has a first outer diameter and the resilient damper member has a second outer diameter that is greater than the first outer diameter.

7. The assembly according to claim 2, wherein the bush is a metal material and the mounting flange is a plastic or composite material.

8. The assembly according to claim 1 wherein the spring member is a coil spring.

9. The assembly according to claim 1, wherein the resilient damper member is a rubber or polymer material.

10. The assembly according to claim 1, further comprising a valve cover defining an aperture within which the second end portion of the shaft is received, wherein the valve cover is the engine component to which the fastener couples the mounting flange.

11. The assembly according to claim 10, wherein the aperture of the valve cover is threaded and threadably engages the second end portion of the shaft.

12. The assembly according to claim 1, wherein the head includes a tool engagement portion and a washer portion.

13. The assembly according to claim 12, wherein the washer portion is coupled to the tool engagement portion for common rotation.

14. An assembly for an engine comprising:
an engine component defining an aperture;
a connected component including a mounting flange, the mounting flange defining a flange bore;
a fastener coupling the connected component to the engine component, the fastener including a head and a shaft, the shaft extending axially from the head and extending through the flange bore, a distal end portion of the shaft being received in the aperture of the engine component;
a biasing member that biases the mounting flange axially away from the head and toward the engine component; and
a damper member disposed axially between the mounting flange and the engine component.

15. The assembly according to claim 14, wherein the engine component is a valve cover and the connected component is an ignition coil.

16. The assembly according to claim 14 further comprising a bush, the bush including a main body and a bush flange that extends radially outward of the main body, wherein the biasing member biases the bush flange axially toward the mounting flange.

17. The assembly according to claim 14 further comprising a bush, wherein the damper member is disposed about the shaft and has an outer diameter greater than an outer diameter of the bush.

18. The assembly according to claim 14, wherein the aperture of the engine component is threaded and threadably engages the distal end portion of the shaft.

19. An assembly for an engine comprising:
a valve cover defining a threaded aperture;
an ignition coil including a coil body and a mounting flange, the mounting flange defining a flange bore;
a fastener including a head and a shaft, the shaft extending axially from the head and extending through the flange bore, a distal end portion of the shaft is threaded and matingly engaged with the threaded aperture;
a biasing member disposed about the shaft and axially between the head and the mounting flange, the biasing member biasing the mounting flange axially away from the head; and
a damper member disposed about the shaft and axially between the mounting flange and the valve cover, the damper member inhibiting contact between the valve cover and the mounting flange.

20. The assembly according to claim 19 further comprising a bush including a first portion and a second portion, the first portion having a first diameter, the second portion having a second diameter, wherein the first diameter is greater than the second diameter, wherein the first diameter is greater than a diameter of the biasing member, and wherein the second diameter is greater than a diameter of the damper member.
